(19) United States
(12) Patent Application Publication
(10) Pub. No.: US 2005/0139276 A1
(43) Pub. Date: Jun. 30, 2005

(54) Method and apparatus for the distribution of fluids

(76) Inventor: Jean-Luc Edouard L. Morelle, Liege (BE)

Correspondence Address: DEAN D. SMALL (12553 + 1000), ARMSTRONG TEASDALE LLP, ONE METROPOLITAN SQUARE, SUITE 2600, ST. LOUIS, MO, 63102-2740, US

(21) Appl. No.: 11/010,142

(22) Filed: Dec. 10, 2004

(30) Foreign Application Priority Data
Dec. 11, 2003 (FR) FR 03 51031

(51) Int. Cl. F16K 11/10

(52) U.S. Cl. 137/887

(57) ABSTRACT

An apparatus for distributing fluid comprises a circular, cylindrical valve body and a circular, cylindrical core. The body is centered with respect to a cylinder axis and has a perimeter. Three outlets, each of which communicates with one of three conduits, are positioned at 120 degrees relative to each other on the perimeter of the body. The core comprises a channel and a rotational axis which is collinear with respect to the cylinder axis of the body. The core has a periphery and fits into the body wherein the perimeter and periphery are in communication with each other. The core is rotatable within the body, and the channel connects two of the three outlets of the body to each other according to the position of the core with respect to the body.

### CROSS REFERENCE TO RELATED APPLICATIONS

This application claims priority to Application number FR 03 51031, titled “Three-way tap for the distribution of fluids, and its use”, filed in France on Dec. 11, 2003, which is hereby incorporated by reference in its entirety.

### BACKGROUND OF THE INVENTION

This invention relates generally to perfusion devices used to perform synthetic chemistry operations for the production of pharmaceutical compounds. In particular, the present invention relates to a three-way valve for the distribution of fluids.

Perfusion devices, which are used classically in medicine, especially for providing care to bed-ridden patients, include one or more three-way valves. These devices are fed by pouches, bottles, syringes and the like through conduits. A valve is normally placed on the conduit which goes from the fluid container to the perfusion device. When several different fluids are to be administered, there are known ways of placing a three-way valve, also referred to as a three-way tap, for each fluid. Two passages of the valve are located on a main conduit while the third passage is connected to the fluid container. In certain cases, if the number of fluids to be injected is great, an array or bank of three-way valves may be cascade-mounted on the main conduit.

The valves conventionally used in the field of perfusion devices are of the core valve type. This kind of valve consists of a cylindrical part drilled with a radial channel, which is the core. This part can rotate on its axis and is inserted into a fixed valve body provided with at least two holes. When a hole of the channel of the core faces a hole of the fixed body, the valve is open on this outlet (which may be an inlet). When the core is turned to a position in which no hole of the channel comes before a given outlet of the fixed body, this outlet is closed.

The three-way valve is classically formed by a fixed body provided with three holes placed at 90° with respect to each other. A T-shaped channel is formed by drilling a first channel going from one side of a core to the other along a diameter. A half-channel is then drilled from the periphery of the core at right angles to the first channel, leading up perpendicularly into the middle of the first channel. In a first position of the core, a first outlet from the body, facing a first half-channel that is along the diameter, is thus connected to a second outlet from the body, facing the half-channel at right angles. In a second position of the core, the second outlet of the body facing the half-channel at right angles is thus connected to a third outlet of the body facing the second half-channel that is along the diameter. In a third position of the core, the outlets of the body facing the two half-channels placed along the diameter are connected to each other. In a fourth and last position of the core, the three outlets are connected to each other.

When used in a process of chemical synthesis, the aforementioned three-way valve raises a problem of rinsing. In every case except the last one, a channel segment remains filled with a fluid that has gone through it in a previous step. Therefore, when different solutions are to be transferred in succession through the valve, numerous rinsing steps are required to prevent the remaining fluid from polluting the next solution.

An additional concern with currently available valves is the high cost. If the valve is integrated into a device designed for one-time use, whereby the valve is to be disposable, the cost of purchasing replacement valves may be prohibitive.

Therefore, apparatus and method are desired to distribute fluids that address the problems noted above and others previously experienced. Certain embodiments of the present invention are intended to meet these needs and other objectives that will become apparent from the description and drawings set forth below.

### BRIEF DESCRIPTION OF THE INVENTION

In one embodiment, an apparatus for distributing fluid comprises a circular, cylindrical valve body and a circular, cylindrical core. The body is centered with respect to a cylinder axis and has a perimeter. Three outlets, each of which communicates with one of three conduits, are positioned at 120 degrees relative to each other on the perimeter of the body. The core comprises a channel and a rotational axis which is collinear with respect to the cylinder axis of the body. The core has a periphery and fits into the body wherein the perimeter and periphery are in communication with each other. The core is rotatable within the body, and the channel connects two of the three outlets of the body to each other according to the position of the core with respect to the body.

In another embodiment, a method for distribution of fluid comprises inserting a circular, cylindrical core into a circular, cylindrical valve body to form a three-way valve. The body comprises three outlets positioned equidistant relative to each other on a perimeter, each of which communicate with one of three conduits. The core comprises a channel having first and second holes at either end for conveying fluid between two of the outlets. By rotating the core to a first position, the channel interconnects two of the outlets.

In another embodiment, an apparatus for the distribution of fluid comprises an array of at least two three-way valves. Each of the three-way valves comprises a circular, cylindrical valve body and a circular, cylindrical core. The body is centered with respect to a cylinder axis and has a perimeter with three outlets positioned at 120 degrees relative to each other which communicate with one of three conduits. The core comprises a rotational axis which is collinear with respect to the cylinder axis. The core has a periphery and fits into the body with the perimeter and periphery in communication with each other. A channel within the core connects two of the three outlets of the body to each other according to a position of the core with respect to the body. A common general conduit is in communication with at least one of the outlets of each of the three-way valves and interconnects the array.

### BRIEF DESCRIPTION OF THE DRAWINGS

FIG. 1 illustrates a cut away view of an array of three-way valves formed in accordance with an embodiment of the present invention.

FIG. 2 illustrates a view of the core of the three-way valve formed in accordance with an embodiment of the present invention.

FIG. 3 illustrates a first embodiment formed in accordance with an embodiment of the present invention.

FIG. 4 illustrates a second embodiment formed in accordance with an embodiment of the present invention.

FIG. 5 illustrates a third embodiment formed in accordance with an embodiment of the present invention.

FIG. 6 illustrates a fourth embodiment formed in accordance with an embodiment of the present invention.

The foregoing summary, as well as the following detailed description of certain embodiments of the present invention, will be better understood when read in conjunction with the appended drawings. It should be understood that the present invention is not limited to the arrangements and instrumentality shown in the attached drawings.

### DETAILED DESCRIPTION OF THE INVENTION

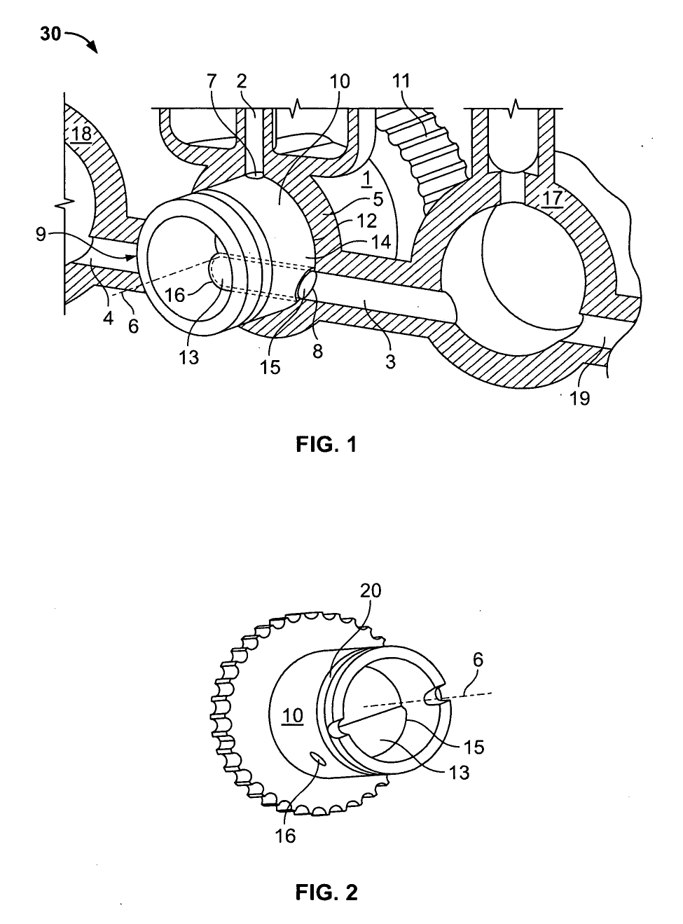

FIG. 1 illustrates a cut away view of an array of three-way valves 30 formed in accordance with an embodiment of the present invention. Three-way valves 1, 17 and 18 are illustrated and are used to distribute fluid (the three-way valves 17 and 18 are partially illustrated). It should be understood that different quantities of three-way valves 1, 17, and 18 may be used to create the array of three-way valves 30. By way of example only, approximately 25 three-way valves 1, 17, and 18 may be interconnected to create an array, also referred to as a ramp or manifold. Alternatively, three-way valves 1, 17 and 18 may be used singularly.

The three-way valves 1, 17 and 18 are formed in the same manner. Thus, only exemplary three-way valve 1 will be discussed. The three-way valve 1 has a circular, cylindrical valve body 5. The body 5 is centered with respect to a cylinder axis 6. The body 5 is provided with three outlets 7, 8 and 9 forming access points for three conduits 2, 3 and 4, respectively. The three outlets 7, 8 and 9 of the body 5 are positioned at 120° relative to one another on a circular, cylindrical perimeter 12 of the body 5.

The three-way valve 1 has a circular, cylindrical core 10. The core 10 fits into the body 5. The core 10 has a periphery 14 and an axis of rotation that is collinear with the cylinder axis 6. The core 10 comprises a secant channel 13 leading out on either side to the periphery 14 of the core 10. Holes 15 and 16 are at either end of the channel 13. The channel 13 is called secant because it is preferably straight and follows a non-diametrical secant line positioned on the circular cylindrical perimeter 12. In other words, the channel 13 is straight and off-center with respect to the cylinder axis 6. Depending upon the position of the core 10 in the body 5, the channel 13 connects two of the three outlets 7, 8 and 9 of the body 5 to each other. In order to orient the core 10 within the body 5 as desired, the core 10 may be attached to a wheel 11.

As illustrated in FIG. 1, the channel 13 leads out into the periphery 14 so as to be facing the outlets 8 and 9. Holes 15 and 16 corresponding to the ends of the channel 13 are facing the outlets 8 and 9 of the body 5. The holes 15 and 16 are located at the ends of a circular sector with a 120° angle and are centered on a trace of the axis 6. In the position shown, a fluid may be conveyed from the conduit 4 to the conduit 3, or vice versa. In other words, the conduits 3 and 4 are an extension of each other, connected by the interposed channel 13. If the core 10 were to be rotated by 120° from the position shown, the channel 13 would connect the conduits 2 and 3 or the conduits 2 and 4 to each other. Therefore, by rotating the core 10, a fluid may be conveyed by a first conduit 2 and distributed to either of two conduits 3 and 4 of the three-way valve 1.

FIG. 2 illustrates a view of the core 10 of the three-way valve 1 formed in accordance with an embodiment of the present invention. The channel 13 is straight and offset relative to the cylinder axis 6. The channel 13 therefore does not follow a diameter.

Such an arrangement favors the making of the ramp, bank, or array of three-way valves 30. Returning to FIG. 1, the three-way valves 17 and 18 are placed on either side of the three-way valve 1. The conduits 3 and 4 may serve to connect a battery of conduits 2 of each of these three-way valves to a common, general conduit 19. In addition, any pair of conduits 2 may be interconnected.

The body 5 and the core 10 may be made of plastic, especially with a view to a one-time type of use. It should be appreciated, however, that other suitable materials may be used. By way of example only, the core 10 may have a diameter of 8 millimeters (mm) and the channel 13 may have a diameter of 1 to 2 mm. The core 10 may be hollow, having only a wall of the channel 13 within the peripheral wall 14. The entire core 10 may be made by injection molding. In addition, the core 10 is provided with a clip 20 and the body 5 of the three-way valve 1 provides a recess on an interior surface of the body 5 (the recess is not shown) to receive the clip 20. In this way, the assembly, and the holding of the core 10 and body 5 of the three-way valve 1 may be facilitated. By forming the valve 1 with plastic or other similar material, when using the three-way valve 1 for perfusion, there is no need to make a sealing joint. The periphery 14 of the core 10 and perimeter 12 of the body 5 facing each other are smooth enough to permit free rotation and to maintain a tight seal at low pressure.

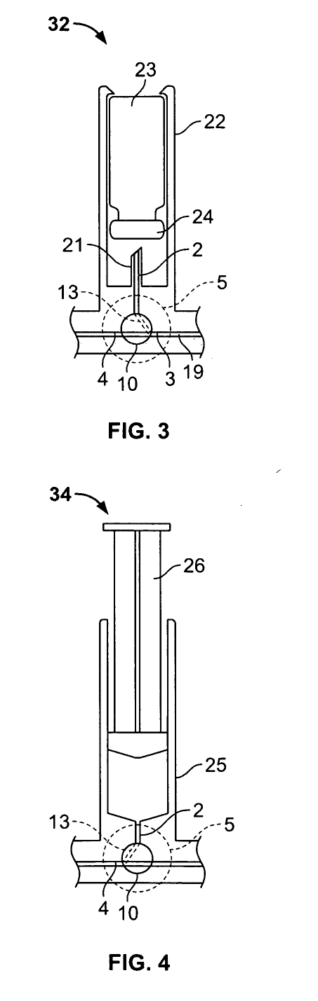

FIGS. 3-6 illustrate four possible implementations of use for the three-way valves 1, 17 and 18. FIG. 3 illustrates a first embodiment 32 formed in accordance with an embodiment of the present invention. The body 5 is provided with a hollow needle 21 which may extend into the conduit 2. The hollow needle 21 may be placed at the base of a receptacle 22, which may be continuous or open, and thus capable of receiving a bottle 23. The needle 21 is designed to perforate a plug 24 of the bottle 23. The hollow needle 21 conveys fluid from within the bottle 23 through channel 13 of the core 10 to conduit 3.

FIG. 4 illustrates a second embodiment 34 formed in accordance with an embodiment of the present invention. The valve body 5 is provided with a receptacle 25 to receive a syringe piston 26. The receptacle 25 opens into the conduit 2, and fluid is conveyed through channel 13 to conduit 4.

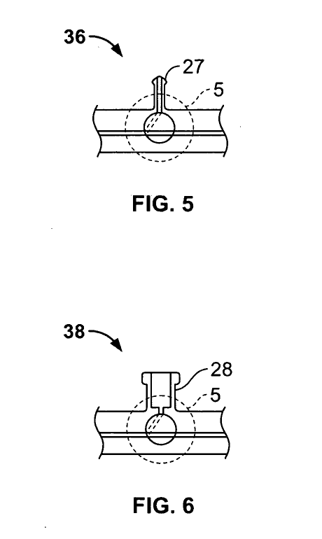

FIG. 5 illustrates a third embodiment 36 formed in accordance with an embodiment of the present invention, wherein the body 5 is provided with a grooved connecting piece 27 to receive a tube or other conduit. FIG. 6 illustrates a fourth embodiment 38 formed in accordance with an embodiment of the present invention, wherein the body 5 is provided with a standardized receiver 28 of syringe tips.

By way of example only, the three-way valve 1 may be integrated into a radiochemical synthesis device for one-time use. The three-way valve 1 provides a lower cost solution with no mixing of undrained fluid, as was previously experienced.

While the invention has been described in terms of various specific embodiments, those skilled in the art will recognize that the invention can be practiced with modification within the spirit and scope of the claims.

1. An apparatus for distributing fluid, comprising:
a circular, cylindrical valve body comprising a cylinder axis and a perimeter, said body being centered with respect to said cylinder axis;
said body further comprising three outlets being positioned at 120 degrees relative to each other on said perimeter, each of said three outlets communicating with one of three conduits;
a circular, cylindrical core comprising a rotational axis and a channel, said rotational axis being collinear with respect to said cylinder axis;
said core further comprising a periphery, said core fitting into said body, said perimeter and said periphery being in communication with each other, said core being rotatable within said body; and
said channel connecting two of said three outlets of said body to each other according to a position of said core with respect to said body.

2. The apparatus of claim 1, wherein said channel of said core is one of secant and straight.

3. The apparatus of claim 1, wherein said channel of said core is straight, said channel being offset with respect to said rotational axis.

4. The apparatus of claim 1, wherein said core is hollow.

5. The apparatus of claim 1, further comprising a wheel being attached to said core to rotate said core within said body.

6. The apparatus of claim 1, wherein said channel has a diameter within a range of about 1 mm to about 2 mm.

7. The apparatus of claim 1, wherein said core has a diameter of about 8 mm.

8. The apparatus of claim 1, wherein said core and said body comprise plastic.

9. The apparatus of claim 1, wherein said core and said body are formed by injection molding.

10. The apparatus of claim 1, further comprising:
a clip in communication with said periphery of said core; and
said perimeter of said body further comprising a recess receiving said clip to retain said core within said body.

11. The apparatus of claim 1, said body further comprising a hollow needle extending into one of said three conduits, said hollow needle conveying fluid into said one of said three conduits.

12. The apparatus of claim 1, further comprising:
a receptacle for receiving a bottle having a plug; and
said body further comprising a hollow needle extending into one of said three conduits, said receptacle being positioned with respect to said hollow needle to facilitate perforating said plug with said hollow needle.

13. The apparatus of claim 1, further comprising a receptacle for receiving a syringe piston, said receptacle opening into one of said three conduits to convey fluid into said one of said three conduits.

14. The apparatus of claim 1, said body further comprising one of a syringe piston receptacle, a grooved connecting piece, and a syringe tip receptacle interconnecting with one of said three conduits to convey fluid into said one of said three conduits.

15. A method for distribution of fluid, said method comprising:
providing a circular, cylindrical core in a circular, cylindrical valve body to form a three-way valve, said body comprising a perimeter and first, second, and third outlets being positioned equidistant relative to each other on said perimeter, each of said first, second, and third outlets communicating with one of three conduits, said core comprising a channel having first and second holes at either end for conveying fluid between two of said first, second, and third outlets; and
configuring said three-way valve wherein in a first position of said core, said channel interconnecting two of said first, second, and third outlets.

16. The method of claim 15, further comprising rotating said core to a second position being 120 degrees with respect to said first position, wherein said channel interconnecting two outlets of said first, second, and third outlets, said two outlets being different with respect to said first position.

17. The method of claim 16, further comprising rotating said core to a third position being 240 degrees with respect to said first position, wherein said channel interconnecting two outlets of said first, second, and third outlets, said two outlets being different with respect to said first and second positions.

18. An apparatus for the distribution of fluid, comprising:
an array of three-way valves, each of said three-way valves comprising:
a circular, cylindrical valve body comprising a cylinder axis and a perimeter, said body being centered with respect to said cylinder axis, said body further comprising three outlets and three conduits, said three outlets being positioned at 120 degrees relative to each other on said perimeter and communicating with one of said three conduits;
a circular, cylindrical core comprising a rotational axis and a channel, said rotational axis being collinear with respect to said cylinder axis, said core further comprising a periphery, said core fitting into said body wherein said perimeter and said periphery being in communication with each other, said channel connecting two of said three outlets of said body to each other according to a position of said core with respect to said body; and
a common general conduit interconnecting said array, said common general conduit being in communication with at least one of said three outlets of each of said three-way valves.

19. The apparatus of claim 18, said array further comprising approximately 25 three-way valves.

20. The apparatus of claim 18, wherein said common general conduit being in communication with two of said three outlets of at least one of said three-way valves.
